(19) United States
(12) Patent Application Publication
(10) Pub. No.: US 2005/0218192 A1
(43) Pub. Date: Oct. 6, 2005

(54) Method and system of inertia friction welding

(76) Inventors: Jeff Lovin, Mishawaka, IN (US); Robert Adams, Granger, IN (US); Dan Kuruzar, Dowagiac, MI (US); Dietmar Spindler, Niles, MI (US)

Correspondence Address: BARNES & THORNBURG LLP, 600 1st Source Bank Center, 100 North Michigan, South Bend, IN, 46601-1632, US

(21) Appl. No.: 10/814,467

(22) Filed: Mar. 31, 2004

(51) Int. Cl. B23K 20/12

(52) U.S. Cl. 228/113; 228/102

(57) ABSTRACT

A method and system of inertia friction welding of work parts welded with a specified angular orientation with respect to each other. The method and apparatus comprises loading a sample work part into a rotating chuck attached to a spindle and loading another sample work part into a non-rotating chuck and then applying torque to the spindle to accelerate the spindle to achieve a predetermined first rotational speed. Next, the sample work parts are inertia friction welded together to form a sample weld. Then, the system measures and stores data related to the deceleration of the spindle during the sample inertia friction weld. The welded sample work parts are removed from the rotating and the non-rotating chucks. The system then calculates a sample deceleration profile of the spindle from the data acquired during the formation of the sample weld. Next, a production work part is loaded into the rotating chuck and another production work part is loaded into the non-rotating chuck. The system applies torque to the spindle to accelerate the spindle to the predetermined first rotational speed which is maintained a rotary position of the spindle matches a calculated value. The system then inertia friction welds together the production work parts to form a production weld. During the formation of the production weld, the system controls torque applied to the spindle during the inertia friction welding of the production work parts so that the spindle deceleration during the formation of the production weld matches the sample deceleration profile of the spindle during the formation of the sample weld and so that the production weld ends in the specified angular orientation of the work parts with respect to each other.

The present disclosure relates to a method and system of inertia friction welding together work parts.

Inertia friction welding is a variation of rotational friction welding in which the energy required to make the weld is supplied primarily by stored rotational kinetic energy of the welding machine. Typically, in inertia friction welding, one of the work parts is connected to a spindle and the other is restrained from rotating. The spindle may be equipped with an attached flywheel to increase its rotational mass and thus its moment of inertia. The spindle is accelerated to a predetermined rotational speed, storing the required energy. The drive motor is then typically disengaged and the work parts are forced together which causes the meeting faces of the parts to rub together under pressure. The kinetic energy stored in the rotating flywheel dissipates as heat through friction at the weld interface as the spindle's rotational speed decreases. If desired, an increase in friction welding force may be applied before rotation stops. The force applied to the contacting work parts is maintained for a predetermined time after rotation ceases. When the inertia friction weld is executed in this manner, the final orientation of the two work parts in the welded product is random and unpredictable.

Direct drive friction welding is also a variation of rotational friction welding. In contrast to inertia friction welding, the energy required to make the weld in direct drive friction welding is supplied primarily by the welding machine through a direct motor connection for a preset period of the welding cycle. Typically, the motor driven spindle and work part are rotated at a predetermined constant speed. The work parts to be welded are forced together and a friction welding force is applied. This continues for a predetermined time, or until a preset amount of axial shortening (upset) takes place. The friction welding force is maintained, or increased, for a predetermined time after rotation ceases.

Inertia friction welding has several advantages over the direct drive friction welding process. The use of the flywheel as a means of storing energy, similar to the way a capacitor stores electrical energy, allows inertia welding machines to discharge their energy into the weld over a shorter time, resulting in shorter weld times, less flash, and narrower heat-affected zones. The drive system for a large direct drive friction welding machine is required to be much larger than the corresponding drive system on an inertia friction welding machine. The inertia weld cycle is simpler to specify and simpler to monitor since the inertia weld cycle has two adjustable parameters for welding: speed and pressure. The direct drive cycle typically has at least seven adjustable parameters: 1 speed, 3 pressures, 2 times, and either a time or length parameter to specify when to end the second friction phase. Additionally, in inertia friction welding, the helical flow lines induced in the material as a result of hot working the interface at the formation of the weld, as the parts are forged while the one part is still rotating, has shown beneficial effects on weld strength.

Further, inertia friction welding can be used to join similar and dissimilar metals in a short period of time compared to more conventional welding methods. Additionally, inertia friction welding is versatile and can be used to join a wide range of part shapes, materials and sizes while minimizing joint preparation to produce a quality weld. Current inertia friction welding cycles, though, cannot achieve angular orientation of the work parts in the welded product. With increased demands on manufacturing output efficiency, however, it is crucial that friction welding processes consistently produce in a cost-effective manner same welded products with same or near same angular orientations.

### SUMMARY

The present disclosure relates to a method and system of inertia friction welding work parts in a manner that results in the two work parts welded with a specified angular orientation with respect to each other. The method includes welding together a first pair of sample work parts and subsequently welding together a second pair of production parts while controlling the deceleration of the spindle in order to duplicate the deceleration profile of the sample weld. In doing so, the total number of spindle revolutions is duplicated, and the final orientation of the production work parts can be precisely controlled. The first pair of work parts may, for example, be a sample or trial pair of work parts. As is typical in inertia friction welding, the angular orientation of these first two sample parts following the weld will be random. During the welding of the first pair of sample work parts, data relating to the deceleration of the spindle is stored and then later used to control torque applied to the spindle during the welding of the second pair of production work parts so that the total number of spindle revolutions of the second pair of production work parts precisely duplicates the number of spindle revolutions measured in the first pair of sample parts. The deceleration profile data also can thereafter be used to control torque applied to the spindle during the welding of any number of additional pairs of similar production work parts. The method can be carried out by any suitable welding system.

The present disclosure relates to a system for inertia friction welding work parts in a manner that results in two work parts welded with a specified angular orientation with respect to each other. The system can be used, for example, to carry out the method of welding together components of the present disclosure.

Additional features of the present disclosure will become apparent to those skilled in the art upon consideration of the following detailed description of illustrative embodiments of the disclosure.

### BRIEF DESCRIPTION OF THE DRAWINGS

The detailed description particularly refers to the accompanying figures in which:

FIG. 1 is an elevational view, schematic in nature, of a weld system in accordance with an embodiment of the present disclosure;

FIG. 2 is a diagram illustrating components of the weld system of FIG. 1;

FIG. 3 is a flowchart illustrating steps of a method for welding together a sample or trial pair of work parts in accordance with an embodiment of the present disclosure;

FIG. 4 is a register of examples of parameters that, in combination with a specified deceleration profile of the method of FIG. 3, can be used to execute a production weld;

FIG. 5 is a flowchart illustrating steps of a method for welding together a production pair of work parts based on the deceleration profile of the method of FIG. 3; and

FIG. 6 is a graph illustrating an example of a production weld.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the number and arrangements of components set forth in the following description or illustrated in the drawings.

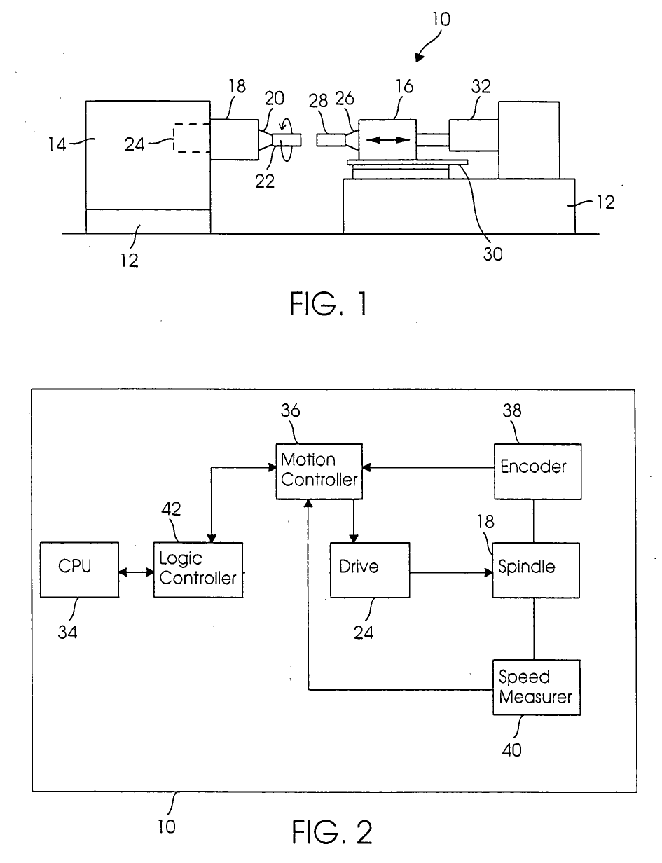

FIG. 1 illustrates a weld system 10 in the form of a friction welder 12. The friction welder 12 includes a headstock portion 14 and a tailstock portion 16 wherein the headstock portion 14 includes a spindle 18 having a rotating chuck 20 for engaging a first work part or component 22. A drive 24 such as a motor is configured to apply a torque to the spindle 18 to rotate the spindle via commands from a motion controller 36 (FIG. 2). The spindle 18 may be equipped with additional mass, such as a flywheel, to increase the moment of inertia of the rotating spindle 18.

The tailstock portion 16 includes a non-rotating chuck 26 for engaging a second work part or component 28. The tailstock portion 16 mounts to a slide 30 wherein an actuator 32 slides the non-rotating chuck 26 toward the rotating chuck 20. Since the rotating chuck 20 and the non-rotating chuck 26 engage the first component 22 and the second component 28, respectively, the first component 22 and the second component 28 contact each other during the weld cycle as will be discussed.

Turning to FIG. 2, the weld system 10 is shown in schematic form further comprising the drive 24, a Central Processing Unit (CPU) 34, a motion controller 36, an encoder 38, a speed measurer 40 and the logic controller 42. The CPU 34 provides an interface to the operator to allow weld parameter entry and storage of weld parameters and communicates the weld parameters to the logic controller 42. The CPU 34 also reads weld data from the logic controller 42, provides an interface to display the weld data to the operator, and stores the weld data. The drive 24 applies torque to accelerate, decelerate, or maintain the rotational speed of the spindle 18. The encoder 38 measures and signals the rotary position (angular orientation) of the spindle 18 to the motion controller 36. The speed measurer 40 measures and signals the rotation speed of the spindle 18 to the motion controller 36, wherein the motion controller 36 represents the intelligence that accepts commands related to spindle 18 speed and position from the logic controller 42 and translates those commands into commands issued to the drive 24. The motion controller 36 has the ability to monitor the position and the speed information of the spindle 18 supplied by the encoder 38 and the speed measurer 40 to adjust the torque output of the drive 24 in real time. The logic controller 42 controls the functions and sequences of the weld system 10 and the friction welder 12 according to the weld parameters supplied by the CPU 34. The source code for the CPU 34 may be written in any suitable manner.

The CPU 34 operatively connects to the logic controller 42 which is operatively connected to the motion controller 36. The motion controller 36 operatively connects to the drive 24 to command the drive 24 to rotate the spindle 18. The encoder 38 measures the angular position of the spindle 18 as it rotates about its axis in rotational increments at set time intervals while the speed measurer 40 measures the speed of the spindle 18. Accordingly, the encoder 38 and speed measurer 40 are operatively connected to the motion controller 36 such that the motion controller 36 analyzes the actual number of rotations during different weld phases such as an acceleration phase, a disengaged phase, a thrust phase and a deceleration phase.

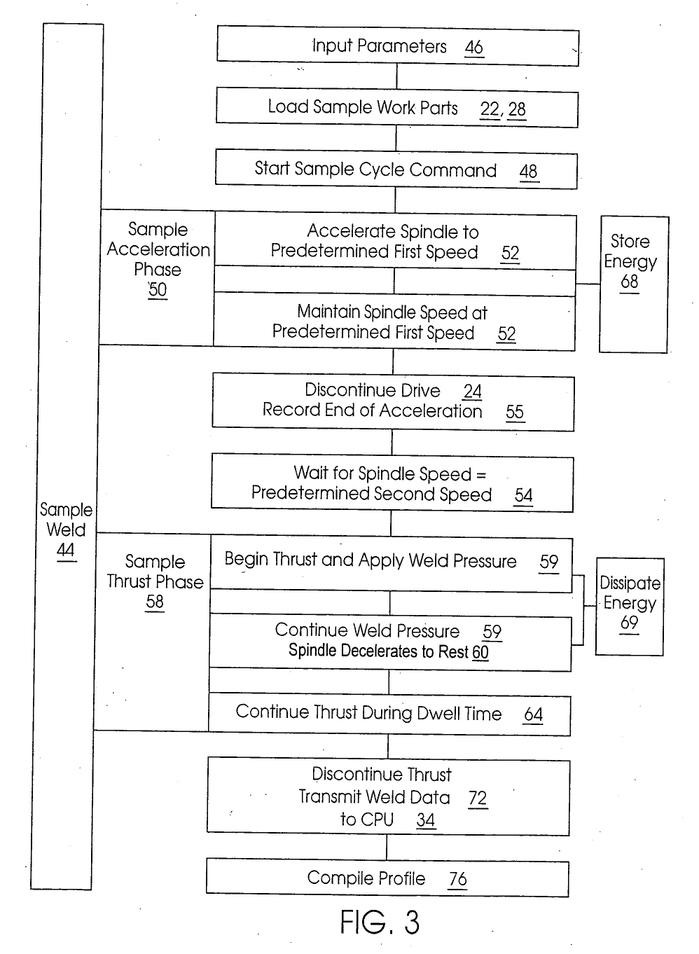

Referring to FIG. 3, for forming a sample or trial weld 44 in accordance with an embodiment of the present disclosure, the operator first inputs weld parameters 46 that define the weld cycle. The operator then loads the pair of sample work parts 22, 28 by engaging the first sample work part 22 with the rotating chuck 20 connected to the spindle 18 while engaging the second sample work part 28 with the non-rotating chuck 26. The rotating and non-rotating chucks 20, 26 are constructed such that the work parts 22, 28 are locked into a known orientation. The configuration of the rotating chuck 20 fixes the orientation of the first sample work part 22 relative to the encoder 38 while the configuration of the non-rotating chuck 26 fixes the orientation of the second sample work part 28 relative to the encoder 38, and thus, also relative to the first sample work part 22. After loading the first pair of sample work parts 22, 28, and inputting the weld parameters 46, the operator issues a start sample cycle command 48 to start the weld cycle.

The spindle 18, initially at rest, rotates via the drive 24 during a sample acceleration phase 50 to achieve a predetermined first rotational speed 52. The drive 24 remains engaged with the spindle 18 to maintain the speed of the spindle 18 at the predetermined first rotational speed 52 for a period of time (a parameter input by the operator). The weld system 10 maintains the predetermined first rotational speed 52 to ensure that the spindle 18 rotates under control at a constant speed. After obtaining control of the spindle 18 and maintaining the predetermined first rotational speed 52, the drive 24 discontinues the application of torque to the spindle 18 allowing the spindle 18 to coast naturally to a predetermined second rotational speed 54. At the moment the drive 24 discontinues the application of torque to the spindle 18, the logic controller 42 records the “End of Acceleration” time mark 55.

After the end of acceleration time 55, the logic controller 42 waits for the spindle 18 to coast naturally from the predetermined first rotational speed 52 to the predetermined second rotational speed 54. When the spindle 18 speed reaches the predetermined second rotational speed 54, the logic controller 42 commands the actuator 32 to move the slide 30, and thus the non-rotating chuck 26, toward the rotating spindle 18. Consequently, the second sample work part 28 contacts the first sample work part 22 during a sample thrust phase 58 and initiates the inertia friction weld of the two sample work parts 22, 28. During the sample thrust phase 58, the actuator 32 maintains a specific weld pressure 59 on the contacting sample work parts 22, 28. As the sample weld 44 forms from the heat created by the friction of the contacting sample work parts 22, 28, the spindle 18 decelerates from the predetermined second rotational speed 54 to rest 60.

When the spindle 18 speed reaches zero 60, the actuator 32 continues to maintain the thrust for a period of time known as the dwell time 64 (a parameter input by the operator). At the end of the dwell time 64, the actuator 32 discontinues the thrust and the weld cycle for the sample weld 44 is complete.

The spindle 18 may be equipped with a flywheel which adds mass to the spindle 18 to increase the rotational kinetic energy 68 stored at ay given rotational speed. The energy 68 associated with a given rotational speed depends on the combined mass of all the components of the welder system 10 that rotate including: the spindle 18, the rotating chuck 24, the part 20 and the flywheel. During the sample thrust phase 58, the stored energy 68 is dissipated as heat 69 into the sample weld 44.

During the sample thrust phase 58, the drive 24 may apply a constant torque to the spindle 18. For example, the drive 24 may apply positive torque, tending to counteract the deceleration of the spindle 18 due to the frictional weld torque and increase the weld time. Alternatively, the drive 24 may apply braking torque, tending to supplement the deceleration of the spindle 18 and decrease the weld time. If a positive torque is applied, however, the magnitude of the torque must be less than the weld torque resulting from contact of the first and second components 22, 28 ensuring that the spindle 18 will decelerate.

The purpose for executing the sample weld 44 is to gather weld data that can be used to characterize the deceleration of the spindle 18 during the inertia friction welding process for the specific production work parts to be welded in subsequent production welds. The data from the sample 44 weld can be analyzed to determine the precise number of spindle rotations at various instants in time from the end of acceleration 55 to zero speed 60. The weld data is compiled into a sample deceleration profile 76. In the context of this invention, a profile is a calculated model of the characteristic deceleration of the spindle 18 during the sample weld cycle. The sample deceleration profile 76 then serves as a basis for controlling subsequent production welds in order to duplicate the total number of spindle 18 rotations, and thus end a production weld cycle at a known orientation of the production work parts.

In the illustrated embodiment, the sample deceleration profile 76 is represented by two arrays of data wherein one array contains spindle 18 revolutions while another array contains the time at which the number of revolutions in the first array was achieved. The spindle 18 revolutions and the time values are both referenced to the end of acceleration time 55, such that time equals zero and the number of revolutions equals zero at the end of acceleration time 55 in the sample weld 44. During subsequent production welds, the motion controller 36 compares actual rotary spindle 18 position to the desired spindle 18 position dictated by the sample declaration profile 76 to generate an error signal. The error signal is then used to adjust drive torque. If the actual production spindle 18 position is behind the model, then the drive 24 applies positive torque to the spindle 18. If the actual production spindle 18 position is ahead of the model, then the drive 18 applies braking torque to the spindle 18.

During the formation of the sample weld 44, the weld system 10 measures and stores data 72 at specific time intervals. The data 72 serve as a basis for calculating the sample deceleration profile 76. The data 72 are typically measured during the entire weld cycle, but the measurements are particularly critical from the time when the spindle 18 achieves the predetermined first rotational speed 52 to the end of acceleration time period 55 to zero speed 60. In the illustrated embodiment, the speed measurer 40 measures the rotational speed of the spindle 18 and the encoder 38 measurers the angular orientation of the spindle 18 at specific time intervals during the entire weld cycle. Additionally, thrust pressure and slide position may also be measured and stored with the weld data. During the formation of the sample weld 44, the weld data is acquired and temporarily stored by the logic controller 42. When the weld cycle is complete, the CPU 34 reads the weld data 72 from the logic controller 42, displays the results to the operator, and stores a complete record of the weld data. The specific data 72 measured and stored can be in any suitable form that can then be used to form the additional welds requiring the same characteristic deceleration profile of the sample weld 44.

In the illustrated embodiment, the weld data 72 used in the calculation of the sample deceleration profile 76 includes the speed of the spindle 18 as a function of time which may be represented as two discrete arrays, one array of spindle 18 speeds and an associated array of time values at which the spindle 18 speed was measured. The weld data 72 further includes rotary position of the spindle 18 as a function of time represented as two discrete arrays, one array of spindle 18 positions and an associated array of time values at which the spindle 18 position was measured. The sample declaration profile 76 may also be calculated by measuring the number of revolutions of the spindle 18 as a function of time during the friction welding of the sample weld 44. The sample deceleration profile 76 may also be calculated by measuring the number of the revolutions experienced by the spindle 18 between the end of acceleration time period 55 and the zero speed 60. After the CPU 34 calculates the sample deceleration profile 76 from the deceleration of the sample weld 44, the welded component is removed in order to execute any number of subsequent production welds.

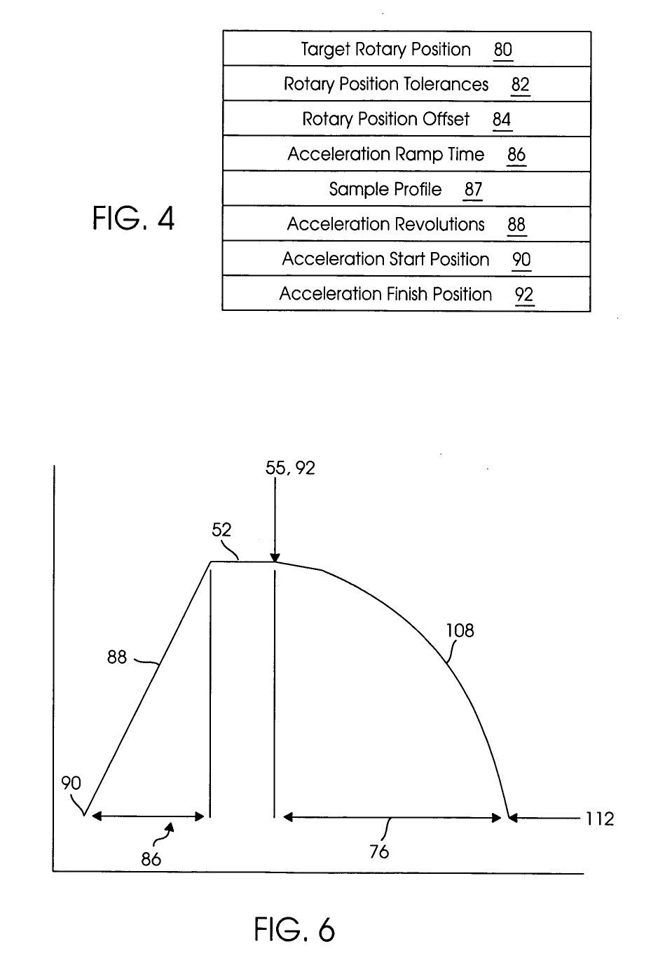

Turning to FIG. 4, weld parameters 46 are entered for use in the formation of production welds 78 (FIG. 5). The parameters 46 include target rotary position 80, rotary position tolerances 82, rotary position offset 84, and acceleration ramp time 86. Additionally, a sample profile 87 is selected. Any number of sample welds 44 may be executed, and the weld data 72 from these welds may be compiled into sample profiles 87 and stored on the CPU 34. The sample profile 87 that is most suitable for the current configuration of production work parts is selected from the list of available profiles. The CPU 34 calculates additional parameters based on the parameters input by the operator above and the characteristics of the sample profile 87 selected. These additional calculated parameters include acceleration revolutions 88, acceleration start position 90, and acceleration finish position 92. All parameters 46, including the profile arrays of revolution and time setpoints, are communicated to the logic controller 42 from the CPU 34 prior to initiating the start of the weld cycle 100.

The rotary position target 80 represents the desired final rotary position of a first production work part 96 fixed to the rotating chuck 20 after the production weld 78 is complete. The rotary position tolerances 82 define the allowable deviations for the target rotary position 80. These tolerances define success/failure of one facet of the production weld 78. The offset 84 is a correction factor that is used to adjust the calculated starting position when the production weld 78 consistently finishes at an orientation that is slightly offset from the rotary position target 80. The acceleration ramp time 86 is the time allowed for the spindle 18 to accelerate from rest to a predetermined rotational speed 52. The predetermined first rotational speed 97 in the production weld 78 must be the same value as the predetermined first rotational speed 52 specified in the selected sample profile weld 44. The acceleration start position 90 represents the orientation that the spindle 18 must have prior to acceleration. The acceleration start position 90 is calculated based on the total number of revolutions in the sample profile 76, the number of acceleration revolutions 88, the target rotary position 80 and the offset 84.

Turning to FIG. 5, the weld system 10 begins the process of inertia friction welding together a pair of production work parts 96, 98 to form the production weld 78. After weld parameters 46 are input by the operator to specify the desired final orientation and the sample profile is selected 87, the first production work part 96 is fixed to the rotating chuck 20 while another production work part 98 is fixed to the non rotating chuck 26. Once the production work parts 96, 98 are loaded, the spindle 18 is rotated until its orientation matches the value specified by the acceleration start position 90 wherein the acceleration start position 90 may incorporate the offset 84 parameter. The operator then issues the production cycle start command 100 for the production weld cycle. The weld cycle starts by accelerating the spindle 18 from rest at the acceleration start position 90 to the predetermined first rotational speed 52 during a production acceleration phase 106. The acceleration of the spindle 18 is controlled in such a way as to produce a linear increase in speed (constant acceleration) over the time period specified by the acceleration ramp time 86.

After linearly accelerating the spindle 18 in the acceleration ramp time 86, the rotational speed of the spindle 18 is maintained at the predetermined first rotational speed 52. The system 10 maintains the rotational speed of the spindle 18 for a specified time interval and then continues to maintain the speed until the rotary position of the spindle 18 matches the acceleration finish position 92. In doing so, an integral number of revolutions is achieved from the moment the spindle 18 speed reaches the first rotational speed 52 until the end of acceleration time 57. From the moment that the spindle 18 position matches the acceleration finish position 92 until the spindle 18 comes to rest at the end of the production weld 98, the motion controller 36 monitors the speed and position of the spindle 18 and manipulates the torque applied to the spindle 18 via the drive 24 in order to duplicate the number of spindle 18 revolutions dictated by the sample deceleration profile 76. At various instants in time, the actual number of spindle 18 revolutions is compared to the desired setpoint defined in the sample deceleration profile 76 for that instant in time, and the torque applied to the spindle 18 is computed from the corresponding error signal. Initially, the spindle 18 speed will decelerate slowly from the predetermined first rotational speed 52 to the predetermined second rotational speed 54, as the motion controller 36 duplicates the natural coast of the spindle 18 that occurred in the sample weld 44. When the spindle 18 speed reaches the predetermined second rotational speed 54, the logic controller 42 commands the actuator 32 to initiate thrust between the production work parts 96, 98 to start a production thrust phase 108.

Unlike the thrust phase 58 in the sample weld 44, the drive 24 remains engaged during the production thrust phase 108 to reproduce the sample deceleration profile 76 of the sample weld 44. In other words, the drive 24 applies torque to the spindle 18 in a production deceleration phase 110 to manipulate the spindle 18 wherein the number of revolutions forming the production weld 78 in the production thrust phase 108 matches the number of revolutions in the sample deceleration profile 76.

As the production weld 78 forms, the spindle 18 decelerates to rest 112. When the spindle 18 reaches production zero speed 112, the actuator 32 continues to maintain the thrust on the production work pieces for a period of time known as the production dwell time 114 (a parameter input by the operator). At the end of the production dwell time 114, the actuator 32 discontinues the thrust and the weld cycle for the production weld 78 is complete.

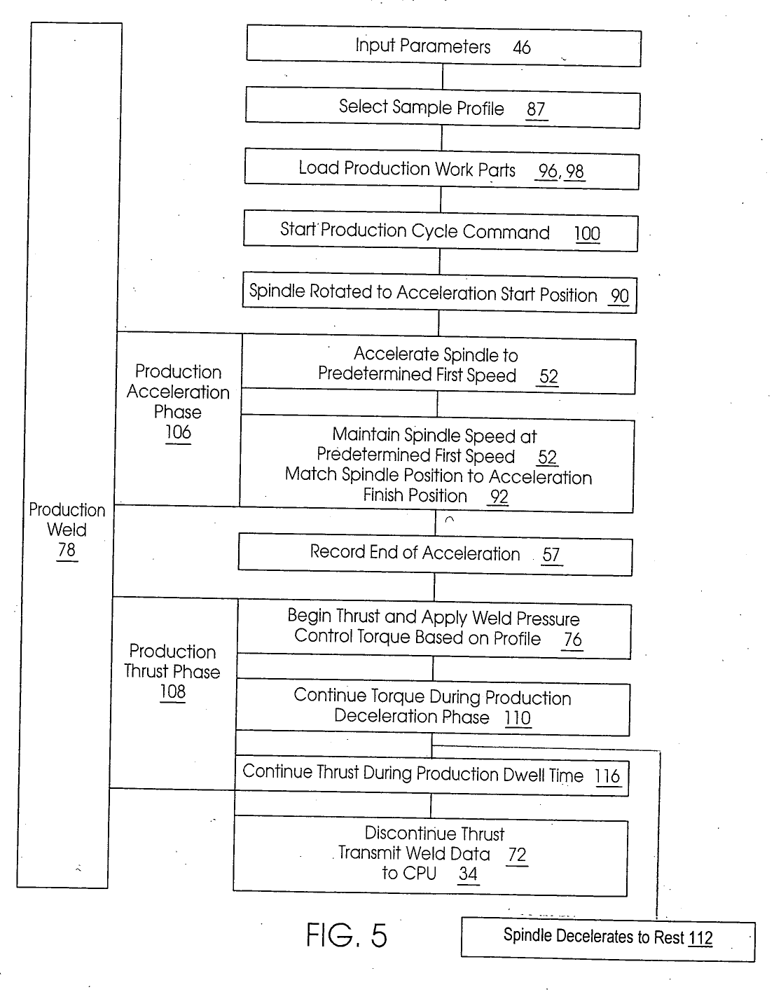

Turning to FIG. 6, the formation of the production weld 78 is shown graphically, wherein the horizontal axis represents time and the vertical axis represents the rotational speed of the spindle 18. Prior to acceleration, the spindle 18 is rotated until its orientation matches the acceleration start position 90. Then, the spindle 18 is linearly accelerated from rest to the predetermined first rotational speed 52 in the time specified by the acceleration ramp time 86. The number of spindle 18 revolutions achieved during this acceleration is calculated as the acceleration revolutions parameter 88. After maintaining the predetermined first rotational speed 52 for the predetermined time interval, the encoder 38 measures the angular orientation of the spindle 18 until the spindle 18 matches the angular finish position 92, wherein the logic controller 42 records the end of acceleration time 57. From this moment, until the spindle 18 decelerates to rest, the motion controller 36 commands the torque applied to the spindle 18 in order to duplicate the deceleration dictated by the sample deceleration profile 76. Via the actions of the motion controller 36 and the drive 24, the spindle 18 decelerates from the predetermined first rotational speed 52 towards the predetermined second rotational speed 54. When the spindle 18 rotational speed reaches the predetermined second rotational speed 54, the logic controller 42 commands the actuator 32 to initiate thrust between the production work parts 96, 98 to start the production thrust phase 108.

The drive 24 remains engaged to the spindle 18 during the production thrust phase 108 to control the torque applied to the spindle 18 during the deceleration of the production weld 78 to match the sample deceleration profile 76 until the spindle 18 reaches production zero speed 112. During the controlled torque, the spindle 18 experiences a non-linear deceleration. As such, by controlling the torque applied to the spindle 18 during the production thrust phase 108, the deceleration profile 102 of the production weld 78, and thus the total number of revolutions of the spindle 18 of the production weld 78 duplicates the deceleration measured and recorded from the sample weld 44.

The method described above in connection with the formation of the production weld 78 may be continuously repeated to weld together on a volume basis production work parts 96, 98. In other words, for example, once the sample deceleration profile 76 has been calculated based on the data 72 collected during the formation of the sample weld 44, the sample deceleration profile 76 may be used to form on a volume basis additional production welds 78.

Accordingly, the present disclosure relates to a method and system for forming inertia friction welds that result in two work parts welded with a specified angular orientation with respect to each other. The method can be carried out by the weld system 10 disclosed herein or by any other suitable welding system. The method may include, for example: loading the sample work part or component 22 into the rotating chuck 20 and loading another sample work part 28 into the non-rotating chuck 26; applying torque to the spindle 18 to accelerate the spindle 18 to achieve the predetermined first rotational speed 52; coasting the spindle 18 to achieve a predetermined second rotational speed 54; inertia friction welding together the sample work parts to form a sample weld 44; calculating the sample deceleration profile 76 of the spindle 18 based on any suitable data relating to the deceleration of the spindle 18 collected during the formation of the sample weld 44; removing the welded-together sample work parts from the chuck 20 and the non-rotating chuck 26; loading the production work part 96 into the rotating chuck 20 and loading another production work part 98 into the non-rotating chuck 26; rotating the spindle 18 to the calculated acceleration start position 90; applying torque to the spindle 18 to accelerate the spindle 18 to the predetermined first rotational speed 52; maintaining the first rotational speed 52 for a specified time interval; maintaining the first rotational speed 52 until the spindle 18 position matches the calculated acceleration finish position 92; inertia friction welding together the production work parts 96, 98 to form a production weld 78 while controlling torque applied to the spindle 18 so that the spindle 18 deceleration during the formation of the production weld 78 matches the sample deceleration profile 76 of the spindle 18 during the formation of the sample weld 44 and so that the final orientation of the work pieces in the product of the production weld 78 has the specified angular orientation with respect to each other. The method may include welding together many additional production work parts 96, 98 based on the deceleration of the spindle 18 during the friction welding of the first pair of work parts 22, 28.

The method may further include applying torque to the spindle 18 to maintain the predetermined first rotational speed 52 of the spindle 18 for a time period after the spindle 18 has been accelerated to the predetermined first rotational speed 52 and before coasting of the spindle 18 and inertia friction welding together the sample work parts 22, 28. It may also include applying torque to the spindle 18 to maintain the predetermined first rotational speed 52 of the spindle 18 for the time period after the spindle 18 has been accelerated to the predetermined first rotational speed 52 and before controlling the torque applied to the spindle 18 while inertia friction welding together the production work parts 96, 98.

Each of the components of the welding system described above may have any suitable construction and each of the work parts may have any suitable construction and may be formed of any suitable materials. Additionally, the welding system may carry out the welding method in accordance with the present disclosure or any other suitable welding method. Similarly, the welding method of the present invention can be carried out by the welding system or by any other suitable welding system.

In general, in order to orient a friction weld, control systems typically monitor the actual orientation of the work part, compare the actual orientation to a desired orientation at that instant in time, and make adjustments to correct for random fluctuations. In both the direct drive and in the inertia weld cycles, this control and adjustment period naturally occurs during the time that the spindle decelerates to rest. As previously discussed, an advantage of the inertia weld cycle is a shorter weld time. While the overall weld cycle is shorter in the inertia weld cycle, the length of time that it take for the spindle to decelerate from weld speed to rest is longer in the inertia cycle. A longer control and adjustment period means that, relative to a control system orienting a direct drive weld cycle, the control system illustrated in this disclosure is able to make more adjustments over a longer time period. Additionally, this disclosure uses prior weld data as the model of the characteristic deceleration during the weld, thus the adjustments needed to duplicate the deceleration defined in the model are typically smaller in magnitude. The accuracy of the orientation of the production weld is improved by the fact that the characteristics of the inertia weld cycle enable the control system to apply relatively more adjustments of smaller magnitude in comparison to orientation of the direct drive weld cycle.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

1. A method of forming inertia friction welds that results in work parts welded with a specified angular orientation with respect to each other, comprising:
loading a sample work part into a rotating chuck attached to a spindle and loading another sample work part into a non-rotating chuck;
applying torque to the spindle to accelerate the spindle to achieve a predetermined first rotational speed;
coasting the spindle to achieve a predetermined second rotational speed;
inertia friction welding together the sample work parts to form a sample weld;
measuring and storing data related to the deceleration of the spindle during the sample inertia friction weld;
removing the welded sample work parts from the rotating and the non-rotating chucks;
calculating a sample deceleration profile of the spindle from the data acquired during the formation of the sample weld;
loading a production work part into the rotating chuck and loading another production work part into the non-rotating chuck;
applying torque to the spindle to accelerate the spindle to the predetermined first rotational speed;
maintaining the predetermined first rotational speed until a rotary position of the spindle matches a calculated value;
inertia friction welding together the production work parts to form a production weld; and
controlling torque applied to the spindle during the inertia friction welding of the production work parts so that the spindle deceleration during the formation of the production weld matches the sample deceleration profile of the spindle during the formation of the sample weld and so that the production weld ends in the specified angular orientation of the work parts with respect to each other.

2. The method of claim 1 further including applying torque to the spindle to maintain the predetermined first rotational speed of the spindle for a time period after the spindle has been accelerated to the predetermined first rotational speed and before coasting of the spindle and inertia friction welding together the sample work parts.

3. The method of claim 2 further including applying torque to the spindle to maintain the predetermined first rotational speed of the spindle for the time period after the spindle has been accelerated to the predetermined first rotational speed and before inertia friction welding together the production work parts.

4. The method of claim 2 further including removing torque after achieving the predetermined first rotational speed and before friction welding together the sample work parts.

5. The method of claim 1 further including transferring energy from the rotating spindle during the inertia friction welding of the sample piece and the other sample work piece.

6. The method of claim 5 wherein the spindle has a mass, the energy being stored by the rotating mass before being transferred by the spindle.

7. The method of claim 6 wherein the spindle includes a flywheel which provides additional mass.

8. The method of claim 1 wherein measuring and storing the data during formation of the sample weld comprises measuring a rotational speed of the spindle and a rotary position of the spindle during deceleration of the spindle.

9. The method of claim 1 wherein controlling torque results in rotating the spindle a same number of revolutions that the spindle rotates during formation of the sample weld.

10. The method of claim 9 wherein calculating the sample deceleration profile includes measuring a rotational speed of the spindle and a rotary position of the spindle as a function of time and wherein controlling the torque executes the same number of revolutions as a function of time during formation of the production weld.

11. The method of claim 1 wherein controlling torque produces a non-linear deceleration of the spindle during the formation of the production weld.

12. The method of claim 1 further comprising recording an end of acceleration time mark.

13. The method of claim 12 wherein the sample deceleration profile is calculated from the end of the acceleration time mark to a rest mark.

14. The method of claim 13 wherein calculating the sample deceleration profile includes measuring a rotational speed of the spindle and a rotary position of the spindle between the end of the acceleration time mark and the rest mark.

15. The method of claim 1 wherein the torque is applied to the spindle by a drive that includes a motor.

16. The method of claim 1 wherein during the inertia friction welding of the sample work parts and of the production work parts the non-rotating chuck is moved towards the spindle to initiate contact of the work parts.

17. The method of claim 16 wherein the non-rotating chuck is moved towards the spindle by a slide.

18. A method of forming inertia friction welds that results in work parts welded with a specified angular orientation, comprising:
(a) loading one of a pair of a sample work parts into a spindle and loading the other of the pair of sample work parts into a non-rotating chuck;
(b) applying torque to the spindle to accelerate the spindle to achieve a predetermined first rotational speed;
(c) coasting the spindle to achieve a predetermined second rotational speed;
(d) inertia friction welding together the pair of sample work parts to form a sample weld;
(e) calculating a sample deceleration profile of the spindle subsequent the formation of the sample weld;
(f) removing the welded-together pair of sample work parts from the spindle and the non-rotating chuck; and
(g) forming a plurality of production welds by:
(i) loading one of a pair of production work parts into the spindle and loading the other of the pair of production work parts into the non-rotating chuck;
(ii) applying torque to the spindle to accelerate the spindle to the predetermined first rotational speed;
(iii) maintaining the predetermined first rotational speed until a rotary position of the spindle matches a calculated value;
(iv) inertia friction welding together the production work parts to form one of the plurality of production welds;
(v) controlling torque applied to the spindle during the inertia friction welding together of the production work parts so that the spindle deceleration during the formation of the production weld matches the sample deceleration profile of the spindle during the formation of the sample weld and so that the production weld ends in the specified angular orientation of the work parts with respect to each other;
(vi) removing the welded-together pair of production work parts from the spindle and non-rotating chuck; and
(vii) repeating (i)-(vi) above with other pairs of production work parts.

19. The method of claim 18 further including applying torque to the spindle to maintain the predetermined first rotational speed of the spindle for a time period after the spindle has been accelerated to the predetermined first rotational speed and before coasting of the spindle and inertia friction welding together the sample work parts.

20. The method of claim 19 further including applying torque to the spindle to maintain the predetermined first rotational speed of the spindle for the time period after the spindle has been accelerated to the predetermined first rotational speed and before inertia friction welding together each pair of production work parts.

21. The method of claim 19 further including removing torque after achieving the predetermined first rotational speed and before inertia friction welding together the sample work parts.

22. The method of claim 18 further including transferring energy from the rotating spindle during the inertia friction welding of the sample work piece and the other sample work piece.

23. The method of controlling of claim 22 wherein the spindle includes a flywheel.

24. The method of claim 18 further comprising measuring and storing data during formation of the sample weld by measuring a rotational speed of the spindle and a rotary position of the spindle during deceleration of the spindle.

25. The method of claim 18 wherein controlling torque results in rotating the spindle a same number of revolutions that the spindle rotates during formation of the sample weld.

26. The method of claim 25 wherein calculating the sample deceleration profile includes measuring a rotational speed of the spindle and a rotary position of the spindle as a function of time and wherein controlling the same number of revolutions as a function of time during formation of the production weld.

27. The method of claim 18 further comprising recording an end of acceleration time mark to obtain the predetermined first rotational speed, and wherein the sample deceleration profile is calculated from the end of the acceleration time mark to a rest mark.

28. The method of claim 27 wherein calculating the sample deceleration profile includes measuring a rotational speed of the spindle and a rotary position of the spindle between the end of the acceleration time mark and the rest mark.

29. A method of forming inertia friction welds that results in work parts welded with a specified angular orientation, comprising:
loading a sample work part into a spindle and loading another sample work part into a non-rotating chuck;
applying torque to the spindle to accelerate the spindle to achieve a predetermined first rotational speed;
coasting the spindle to a predetermined second rotational speed;
contacting together the sample work parts to inertia friction weld together the sample work parts and to form a sample weld, the spindle decelerating and transferring energy as it decelerates to create the sample weld;
measuring and storing data related to the deceleration of the spindle during the sample inertia friction weld;
calculating a sample deceleration profile from the data acquired during the formation of the sample weld by measuring a rotational speed of the spindle and a rotary position of the spindle during the deceleration of the spindle;
removing the welded-together sample work parts from the spindle and the non-rotating chuck;
loading a production work part into the spindle and loading another production work part into the non-rotating chuck;
applying a torque to the spindle to accelerate the spindle to achieve the predetermined first rotational speed;
maintaining the predetermined first rotational speed until a rotary position of the spindle matches a calculated value;
contacting together the production work parts to inertia friction weld together the production work parts and to form a production weld; and
controlling torque applied to the spindle during the inertia friction welding of the production work parts so that the spindle deceleration during the formation of the production weld matches the sample deceleration profile of the spindle during the formation of the sample weld and so that the production weld ends in the specified angular orientation of the work parts with respect to each other.

30. The method of claim 29 wherein the energy transferred from the spindle is stored by a rotating flywheel of the spindle.

31. The method of claim 29 further including applying torque to the spindle to maintain the predetermined first rotational speed of the spindle for a time period after the spindle has been accelerated to the predetermined first rotational speed and before initiating contact between the sample work parts, and applying torque to the spindle to maintain the predetermined first rotational speed of the spindle for the time period after the spindle has been accelerated to the predetermined first rotational speed and before initiating contact between the production work parts.

32. The method of claim 29 further including removing torque after achieving the predetermined first rotational speed and before inertia friction welding together the sample work parts.

33. The method of claim 29 wherein calculating the sample deceleration profile includes measuring a rotational speed of the spindle and a rotary position of the spindle as a function of time and wherein controlling the torque executes the same number of revolutions as a function of time during formation of the production weld.

34. The method of claim 29 wherein controlling torque produces a non-linear deceleration of the spindle during formation of the production weld.

35. The method of claim 29 wherein during the contacting of the sample work parts and of the production work parts the non-rotating chuck is moved towards the spindle to cause contact of the work parts by a slide associated with the non-rotating chuck.

36. An inertia friction weld system, comprising:
a spindle having a flywheel, the spindle being configured to engage one of a first pair of parts in a known orientation;
a drive operatively connected to the spindle to apply torque to the spindle to rotate the spindle;
a non-rotating chuck spaced from the spindle and configured to engage the other of the first pair of parts;
a slide configured to slide the non-rotating chuck toward the spindle to facilitate welding together of the first pair of parts;
a motion controller operatively connected to the drive, the motion controller being configured: to engage the drive to apply torque to the spindle to accelerate the spindle to achieve a predetermined first rotational speed; to disengage the drive to coast the spindle to a predetermined second rotational speed; and to engage the drive and inertia friction weld together a second pair of parts;
a logic controller operatively connected to the motion controller, the logic controller being configured: to initiate contact between the first pair of parts and the second pair of parts; and to measure and store data related to the deceleration of the spindle during the sample inertia friction weld; and
a central processing unit operatively connected to the logic controller, the central processing unit configured: to calculate a sample deceleration profile of the spindle from the data acquired during the formation of a sample weld of the first pair of work parts and to communicate with the motion controller which controls the torque applied to the spindle during formation of a production weld of the second pair of parts so that the spindle deceleration during the formation of the production weld matches the sample deceleration profile of the spindle during the formation of the sample weld and so that the production weld ends in the specified angular orientation of the second pair of parts with respect to each other.

37. The weld system of claim 36 wherein the motion controller and the logic controller are configured to disengage the drive from the spindle during formation of the weld of the first pair of parts.

38. The weld system of claim 37 wherein the motion controller is configured to maintain the predetermined first rotational speed until a rotary position of the spindle matches a calculated value.
